(19) United States
(12) Patent Application Publication
(10) Pub. No.: US 2018/0158011 A1
(43) Pub. Date: Jun. 7, 2018

(54) METHODS AND SYSTEMS FOR PREDICTING WORKFORCE POPULATION

(71) Applicant: CORNING INCORPORATED, Corning, NY (US)

(72) Inventors: Shaylan Terry Barlow, Corning, NY (US); Samuel Thompson Kasserman, Corning, NY (US)

(21) Appl. No.: 15/826,853

(22) Filed: Nov. 30, 2017

Related U.S. Application Data
(60) Provisional application No. 62/428,755, filed on Dec. 1, 2016.

(51) Int. Cl. G06Q 10/06; G06Q 10/10; G06Q 10/04

(52) U.S. Cl. CPC G06Q 10/063112; G06Q 10/04; G06Q 10/0635; G06Q 10/1057

(57) ABSTRACT

Disclosed herein are methods for predicting a future workforce population by compiling a current employee list and assigning a retirement risk factor to employees to determine an employee retirement prediction for a selected year. Computer-implemented systems for carrying out these methods are also disclosed herein.

### CROSS-REFERENCE TO RELATED APPLICATIONS

This application claims the benefit of priority under 35 U.S.C. § 119 of U.S. Provisional Application Ser. No. 62/428,755 filed on Dec. 1, 2016, the content of which is relied upon and incorporated herein by reference in its entirety.

### FIELD OF THE DISCLOSURE

The disclosure relates generally to methods and systems for predicting workforce population, and more particularly to methods and systems for predicting the retirement risk for a workforce population and forecasting future hiring needs.

### BACKGROUND

Forecasting may be used in many different industries to facilitate planning for future needs. In some industries, it may be beneficial to forecast workforce population, e.g., the retirement of employees from the workforce over time, to facilitate the development of a framework for future hiring practices. For example, as the “baby boomer” population ages, it may be important to forecast the impact of the retirement of this demographic on the workforce for various industries.

International corporations with both domestic and foreign offices may also desire to account for different cultural customs as it pertains to retirement. For example, in certain countries the average retirement age may be higher or lower than that of other countries, or other cultural norms or international laws may otherwise control or affect retirement age. It may also be advantageous to compare the costs associated with a future retiree in a current geographical location as compared to a new hire in a different geographical location and to tailor future hiring needs accordingly. Forecasting the effect of retirement incentive packages may also be a useful tool for extending the lifespan of a currently existing workforce population. Finally, it may be advantageous to forecast the level of skill of a future retiree and to adapt or institute training programs to maintain a desired level of expertise within the company.

### SUMMARY

The disclosure relates, in various embodiments, to methods for predicting a future workforce population, the methods comprising compiling a current employee list including an employee age category in a data storage system, programming a computer with operational logic for assigning a retirement risk factor to an employee, and using the computer to determine an employee retirement prediction for a selected subset of the employee list in a selected year, wherein the computer is operationally coupled to and in communication with the data storage system. Also disclosed herein are computer-implemented systems for predicting a future workforce population, the systems comprising a data storage system for compiling a current employee list including an employee age category, and a computer operationally coupled to and in communication with the data storage system, the computer comprising a logic subsystem programmed with an operational logic for assigning a retirement risk factor to an employee and a data processing subsystem for providing an employee retirement prediction for a selected subset of the current employee list in a selected year.

In non-limiting embodiments, the operational logic may assign a retirement risk factor to the employee based on a projected employee age in a selected future year. The employee list further can also include an employee location category and the operational logic can assign a retirement risk factor to an employee based in part on the employee location. According to additional embodiments, a hiring framework may be formulated for the selected year based on the employee retirement prediction. The employee list can further include a skill level category and the hiring framework can be formulated by evaluating employee training programs to assess the need to hire new employees of a give skill level. In yet further embodiments, the employee list can include an employee cost category and the hiring framework can be formulated by evaluating employee costs in other geographical locations to assess potential cost savings associated with hiring new employees in the other geographical locations. According to still further embodiments, a retirement incentive package may be formulated or evaluated based on the employee retirement prediction.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings.

FIG. 1 is a diagram illustrating a computer-implemented system in accordance with various embodiments of the disclosure;

FIG. 2 is a flowchart illustrating methods for predicting a future workforce population in accordance with additional embodiments of the disclosure;

FIGS. 3A-B illustrate workforce population data for an employee subset in a current year;

FIGS. 4A-B illustrate workforce population data for an employee subset in a future year;

FIG. 5 illustrates workforce population data for an employee subset in different regions for a selected year; and

FIG. 6 illustrates workforce population data for an employee subset in different functional categories for a selected year.

### DETAILED DESCRIPTION

Disclosed herein are methods for predicting a future workforce population, the methods comprising compiling a current employee list including an employee age category in a data storage system, programming a computer with operational logic for assigning a retirement risk factor to an employee, and using the computer to determine an employee retirement prediction for a selected subset of the employee list in a selected year, wherein the computer is operationally coupled to and in communication with the data storage system.

Also disclosed herein are computer-implemented systems for predicting a future workforce population, the systems comprising a data storage system for compiling a current employee list including an employee age category, and a computer operationally coupled to and in communication with the data storage system, the computer comprising a logic subsystem programmed with an operational logic for assigning a retirement risk factor to an employee and a data processing subsystem for providing an employee retirement prediction for a selected subset of the current employee list in a selected year.

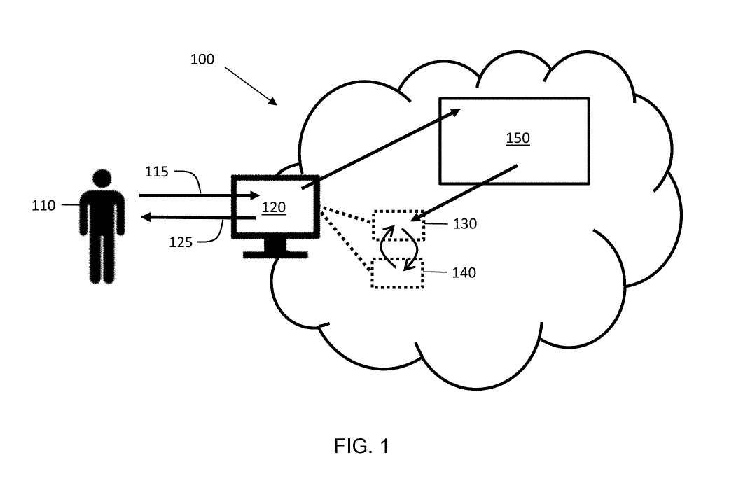

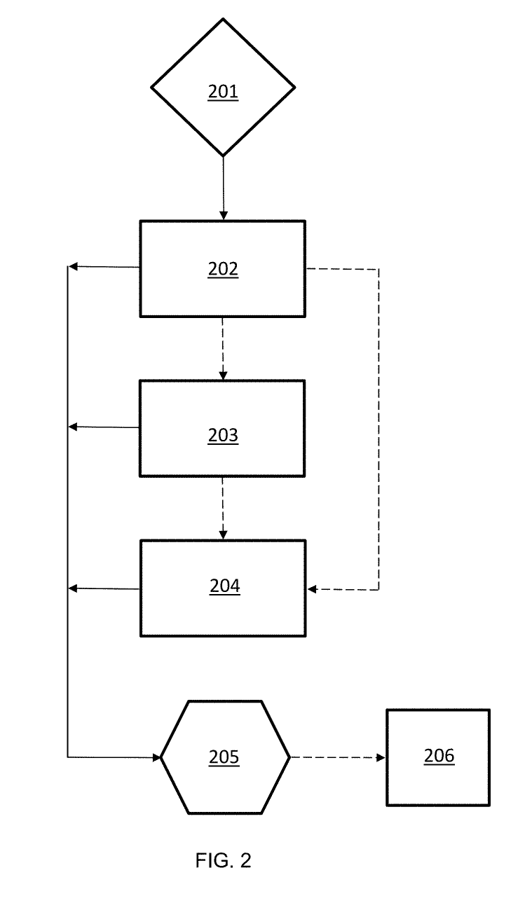

Various embodiments of the disclosure will now be discussed with reference to FIGS. 1-2, which illustrate exemplary embodiments of computer-implemented systems and methods for predicting workforce population. The following general description is intended to provide an overview of the claimed systems and methods, and various aspects will be more specifically discussed throughout the disclosure with reference to the non-limiting depicted embodiments, these embodiments being interchangeable with one another within the context of the disclosure.

FIG. 1 schematically illustrates a non-limiting example of a computer-implemented system 100 configured to be accessed by a user 110 via a computing system 120 to perform one or more methods disclosed herein. The computer-implemented system 100 can, in various embodiments, be used to generate output data 125 containing a workforce population prediction in response to a query 115 from the user 110 for a selected year. The various components and sub-systems of system 100 may be implemented by hardware, software, or a combination thereof, as described in more detail herein.

The computing system 120 may include any type of computing device including, but not limited to, a personal computer. The computing system 120 may be operationally coupled to and in communication with a data storage system 150. The data storage system 150 contains a compiled current employee list including one or more categories such as employee age, employee skill level, employee location, employee cost, and the like, or any combination thereof.

The data storage system may include one or more physical devices configured to store or hold employee data and/or instructions executable by the computing system 120 to access such data. In some embodiments, the data storage system 150 may include removable media and/or integrated or built-in memory devices. The data storage system 150 may include, for example, memory devices such as optical memory devices, semiconductor memory devices (e.g., RAM, EEPROM, flash, etc.), and/or magnetic memory devices, to name a few. The data storage system 150 may also include other devices with one or more of volatile, non-volatile, dynamic, static, read/write, read-only, random access, sequential access, location addressable, file addressable, and/or content addressable operating characteristics. According to various embodiments, the data storage system 150 may be remotely located, e.g., in a location different from the computing system 120 and/or the user 110. In further embodiments, the data storage system 150 may be provided in the form of computer-readable media, which may be used to store and/or to transfer the employee data and/or which may be introduced into the computing system 120 or otherwise accessed by the computing system.

The computing system 120, in response to a user query 115, can access data from the data storage system 150, such as information for a selected employee subset in a selected year. The computing system 120 may thus include one or more user input devices, such as a keyboard, mouse, touch screen, trackball, or the like, which may enable the user to interact with the computing system 120. Additionally, in various embodiments, the computing system may include a display device, such as a screen or monitor, which may be used to present the desired information or data, e.g., in the form of one or more graphs, charts, lists, or the like. For example, the display device may be used to present a visual representation of output data 125 to the user. In certain embodiments, the display device and input device may be combined, such as in a common housing, e.g., a personal computer, or such devices may be separate. The common housing can also include the data processing and/or logic subsystem disclosed below, or one or more of these components may be provided as or in one or more separate or external peripheral devices.

The computing system 120 may further comprise a data processing subsystem 130 and a logic subsystem 140, which may include one or more physical devices configured to execute one or more instructions. Such instructions may be implemented to perform a task, retrieve data, transform the state of the data, transform the state of one or more devices, or any other task necessary to arrive at the desired output result. The data processing and logic subsystems 130, 140 may include one or more processors and/or computing devices configured to execute software instructions. Additionally or alternatively, the subsystems may include one or more components configured to execute hardware or firmware instructions. The subsystems 130, 140 may optionally include individual components that are distributed throughout two or more devices, which may be remotely located in some embodiments. According to further embodiments, the subsystems 130, 140 may be integrated into one or more common devices, such as integrated circuit or a chip.

The data processing subsystem 130 of the computing system 120 can retrieve and process data from the data storage system 150. The data processing subsystem 130 may also be in operational communication with the logic subsystem 140 of the computing system 120, which is programmed with an operational logic for calculating an employee age in a selected year and assigning a retirement risk factor to the employee for the selected year. In certain embodiments, the logic subsystem 140 of the computing system 120 may be programmed with operational logic, such as IF/IFS logic, for assigning the retirement risk factors. The data processing subsystem 130 may also be programmed with modeling macros to code, calculate, and chart employees by the retirement risk factors generated by the logic subsystem 140 for the selected year. The computing system 120 can thus be used to provide workforce retirement prediction data 125 for the selected employee subset in the selected year based on the retirement risk factor.

FIG. 2 illustrates a method for predicting future workforce population in accordance with various embodiments of the disclosure. In step 201, a user may input a query, e.g., by selecting a subset of employees and a future year. The employee subset may be grouped, for example, by company occupation, division, location, area of expertise, and the like. In a non-limiting example, a user may wish to know how many employees with a selected occupation are at risk to retire in a selected year, how many employees in a selected region or country are at risk to retire in a selected year, how many employees in a selected corporate division are at risk to retire in a selected year, and so forth. In certain embodiments, the query may be input into the computing system 120 illustrated in FIG. 1.

Referring again to FIG. 2, in step 202, data for the employee subset may be retrieved from the data storage system 150 and a retirement risk factor may be assigned to each employee in the employee subset based at least in part on their age in the selected future year. The employee data may be retrieved by the data processing subsystem 130 illustrated in FIG. 1 and the retirement risk factor may be assigned to each employee, for example, by the logic subsystem 140 illustrated in FIG. 1.

In certain embodiments, historical company data may be used to generate operational logic parameters for assigning a retirement risk factor. In additional embodiments, the location of the employee may be used to modify the logic parameters, such as based on cultural norms, mandatory retirement age laws, historical data regarding the average retirement age in a selected country or geographical region, and/or future predictions for average retirement age in a selected year. According to various embodiments, a combination of historical company data and cultural data may be used. By way of non-limiting example, the logic parameters for any of columns I-Ill of Table I may be used to assign retirement risk factors to employees for different geographical regions (e.g., North America, Asia, Europe, Africa, etc.). These parameters may also, in some embodiments, be manipulated to reflect a potential retirement incentive program, e.g., to promote or deter early retirement.

TABLE I
Retirement Risk Factor Logic Parameters

| Risk Factor | Region I | Region II | Region III |
|---|---|---|---|
| Low Risk (A) | Age < 50 | Age < 50 | Age < 55 |
| Moderate Risk (B) | 50 ≤ Age < 55 | 50 ≤ Age < 56 | 55 ≤ Age < 60 |
| High Risk (C) | 55 ≤ Age < 60 | 56 ≤ Age < 58 | 60 ≤ Age < 65 |
| Extreme Risk (D) | 60 ≤ Age < 65 | 58 ≤ Age < 60 | 65 ≤ Age < 68 |
| Retired (E) | Age ≥ 65 | Age ≥ 60 | Age ≥ 68 |

From step 202, the process may optionally continue to step 203 and/or 204 (i.e., via the dashed arrows) or may continue directly to step 205 (i.e., via the solid arrow). In optional step 203, the employees within the selected subset that are at a specified retirement risk level (e.g., extreme, high, etc.) in the selected year may be further analyzed to determine their skill level and/or area of expertise. For example, an employee with significant experience and/or knowledge may be flagged for further consideration in optional step 206. In optional step 204 the employees within the selected subset that are at a specified retirement risk (e.g., extreme, high, etc.) in the selected year may be further analyzed to determine the costs associated with their employment. For example, an employee in one geographical location with high associated costs may be flagged for further consideration in optional step 206.

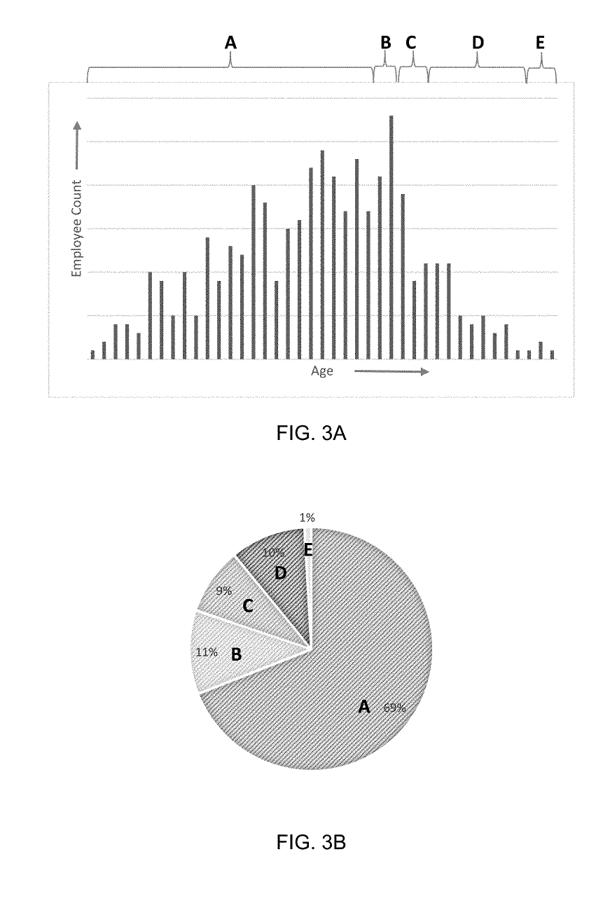

In step 205 the output data may be compiled and analyzed to determine an employee retirement prediction for the selected year. For example, the individual retirement risk factors assigned in step 202 may be compiled to produce an overall employee retirement prediction for the selected employee subset, for instance, what percentage of the employee subset is at extreme risk to retire in the selected year. The employee retirement prediction may also indicate other risk categories, such as what percentage of the employee subset is at high risk to retire, moderate risk to retire, and so forth. In some embodiments, the workforce population data illustrated in FIGS. 3A-B and 4A-B may be generated in response to the query set forth in step 201 and may be presented to the user via a display device of the computing system 120 illustrated in FIG. 1. As shown in FIG. 3A, the output data from step 205 may provide a breakdown of the number of employees having a certain age for the current year in the form of a bar chart or other graphical depiction, from which the general age of the workforce can be assessed. As shown in FIG. 3B, the employees of various ages can be grouped into retirement risk factor groups A-E for the current year in the form of a pie chart or other graphical depiction, from which the general percentage of the workforce population at risk to retire can be assessed.

By way of a non-limiting example, group A may represent a “low” or “no” retirement risk factor (e.g., employees which are not at risk to retire in the selected year); group B may represent a “moderate” retirement risk factor (e.g., employees that are approaching retirement age in the selected year, such as within two years of the earliest age in the retirement age range); group C may represent a “high” retirement risk factor (e.g., employees in the earlier years of the retirement age range in the selected year); group D may represent an “extreme” retirement risk factor (e.g., employees in the later years of the retirement age range in the selected year); and group E may represent the “retired” risk factor (e.g., employees above the retirement age range that are predicted to have departed the company in the selected year).

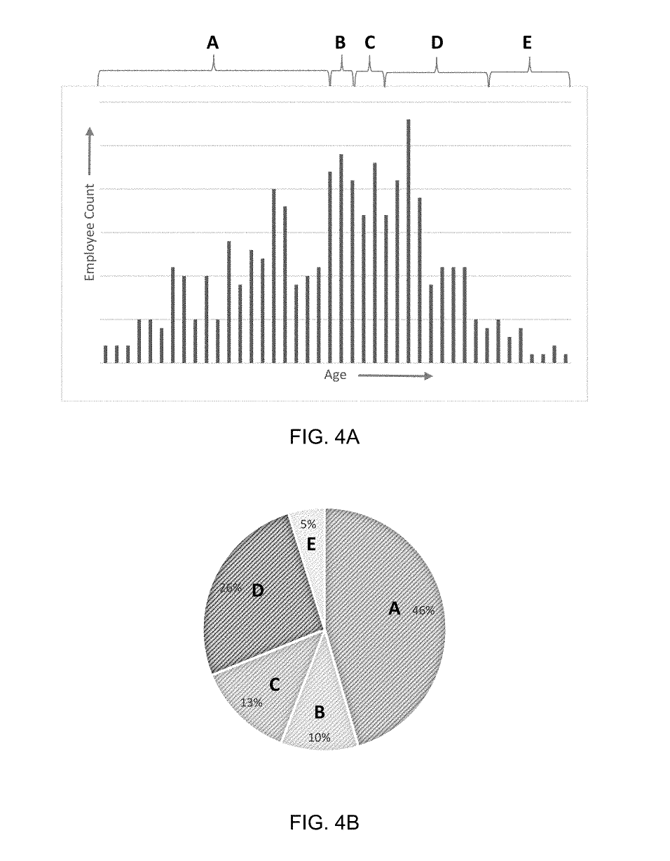

The graphs illustrated in FIGS. 3A-B may likewise be prepared for any future year, as shown in FIGS. 4A-B, and these data may, in some embodiments, be compared to the data for the current year to assess retirement trends. As can be seen in FIG. 4B, a significantly higher percentage of the workforce (26%) is predicted to be at high risk of retirement (group D) in the selected future year as compared to FIG. 3B, in which only 10% of the workforce is at high risk to retire in the current year. Additionally, as illustrated in FIG. 4B, 5% of employees are predicted to have retired (group E) in the selected future year, as compared to only 1% in the current year, as illustrated in FIG. 3B.

Referring back to FIG. 2, after step 205, in which employee retirement prediction data is output to the user, the method can proceed to optional step 206, which may include modifications to current and/or future hiring practices, current and/or future training practices, current and/or future employee demographics, and/or current and/or future retirement incentives. For example, the data generated in step 205 may indicate that a significant percentage of the workforce is at high risk to retire in a selected future year. In step 206, such data may be used to implement or revise hiring practices to promote hiring of new employees to provide a pipeline or buffer of talent to replace the aging members of the workforce.

According to additional embodiments, step 203 may determine that one or more employees with significant expertise and/or training may be at risk to retire in a selected future year. In step 206, the data generated in step 205 may be used to ensure that an internal succession plan is in place and/or to implement or revise training programs within or outside the company to ensure that current employees will have the desired expertise level by the selected future year. Alternatively or additionally, the data generated in step 205 may be used to implement or revise hiring practices to ensure that new hires in the selected year have the desired expertise level or are hired with sufficient time to reach the desired expertise level by the selected future year.

In another non-limiting embodiment, step 204 may determine that one or more employees in a certain geographic location may be at risk to retire in a selected future year. The geographic location may have costs associated therewith, e.g., minimum wage, benefits, training, relocation, cost of living, real estate prices, corporate taxes, property taxes, communication fees, and so forth, that may be mitigated in a different geographical location. Thus, if step 204 determines that one or more employees in a high-cost geographical location will retire in a selected future year, step 206 may be used to determine any cost-saving benefits that may result from relocating that position to a different low-cost geographical location when hiring a new employee. For instance, a predictive model may be implemented that compares the current costs associated with employees in a first geographical location and the potential cost savings associated with relocating all or a portion of any vacated positions in the first geographical location to a second geographical location.

In a further non-limiting embodiment, the data generated in step 205 may be used to simulate potential retirement incentive packages, e.g., packages designed to promote early retirement or to deter early retirement. In such instances, the data for a future year may be compared to data for a modified future year (e.g., with retirement incentives in place), to identify if the desired workforce population can be achieved with a selected incentive package in place. As such, optional step 206 may be used to implement, remove, or revise retirement incentive packages such that the workforce population is modified or maintained as desired in the selected future year.

By way of a non-limiting example, the employee subset in Table II below may be selected by a user to determine an employee retirement prediction in a selected year. The employee subset in Table II may thus represent at least part of a user query in step 201 of FIG. 2. Using the parameters set forth in Table I above, a retirement risk factor may be assigned to each employee for the selected year as set forth in Table III below, e.g., as described in step 202 of FIG. 2.

TABLE II
Exemplary Employee Subset

| | Age | | Technical | |
|---|---|---|---|---|
| Employee | (Current Year) | Location | Area | Expertise |
| E1 | 50 | Region I (R1) | Field II (F2) | Novice |
| E2 | 54 | Region III (R3) | Field V (F5) | Standard |
| E3 | 57 | Region I (R1) | Field I (F1) | Master |
| E4 | 42 | Region II (R2) | Field III (F3) | Novice |
| E5 | 46 | Region I (R1) | Field VII (F7) | Standard |
| E6 | 48 | Region III (R3) | Field IV (F4) | Standard |
| E7 | 56 | Region II (R2) | Field II (F2) | Master |
| E8 | 41 | Region I (R1) | Field VI (F6) | Novice |
| E9 | 44 | Region I (R1) | Field I (F1) | Standard |
| E10 | 62 | Region III (R3) | Field V (F5) | Master |

TABLE III
Risk Factor In Selected Year

| | Age | |
|---|---|---|
| Employee | (Selected Year) | Risk Factor |
| E1 | 55 | High (C) |
| E2 | 59 | Moderate (B) |
| E3 | 62 | High (C) |
| E4 | 47 | Low (A) |
| E5 | 51 | Moderate (B) |
| E6 | 53 | Low (A) |
| E7 | 61 | Retired (E) |
| E8 | 45 | Low (A) |
| E9 | 49 | Low (A) |
| E10 | 67 | Extreme (D) |

Using the individual retirement risk factors presented in Table III, an overall employee retirement prediction may be compiled for the selected subset of the workforce population, e.g., as described in step 205 of FIG. 2. The overall prediction may, for example, indicate that 4 of 10 employees are at low risk to retire in the selected year, 2 of 10 employees are at moderate risk to retire in the selected year, 2 of 10 employees are at high risk to retire in the selected year, 1 of 10 employees is at extreme risk to retire in the selected year, and 1 of 10 employees will retire in or before the selected year.

The analysis may also proceed further, as in steps 203 and/or 204 of FIG. 2, e.g., to evaluate the expertise level and/or location of employees at risk to retire in the selected year. Exemplary skill levels may include, without limitation, “novice” (e.g., employees relatively new to the occupation, field, and/or technology), “standard” (e.g., employees having ordinary skill in the art), and “master” (e.g., employees with significant knowledge and/or expertise), although other skill levels above, below, and in between these exemplary skill levels are contemplated as falling within the scope of the disclosure. In some embodiments, employees E7 (retired) and E10 (extreme) may be flagged in step 203 for further evaluation of their skill level in step 206. Of course, employees with other retirement risk factors (such as high, moderate, etc.) may be flagged as desired for a particular application. In the above non-limiting embodiment, the skill level of employees E7 and E10 is “master.” Thus, in optional step 206 of FIG. 2, these positions may be further evaluated to ensure that an internal succession plan exists to replace employees E7 and E10 and/or to implement or revise training programs within or outside the company to ensure that current employees will achieve a “master” skill level by the selected year. Alternatively, hiring practices may be revised or implemented to ensure that employees hired in the selected year have a “master” skill level or that employees are hired in a year prior to the selected year with sufficient time to reach a “master” skill level by the selected year.

In other embodiments, in step 204, employees E7 (retired) and E10 (extreme) may be flagged for further evaluation of their geographical location in step 206. Of course, employees with other retirement risk factors (such as high, moderate, etc.) may be flagged as desired for a particular application. In the above non-limiting embodiment, the geographical regions of employees E7 and E10 are Region II and Region III, respectively. Thus, in optional step 206 of FIG. 2, these employees may be further evaluated to determine any cost-saving benefits that may result from relocating that position to a different geographical location, e.g., Region I, when hiring a new employee in the selected year.

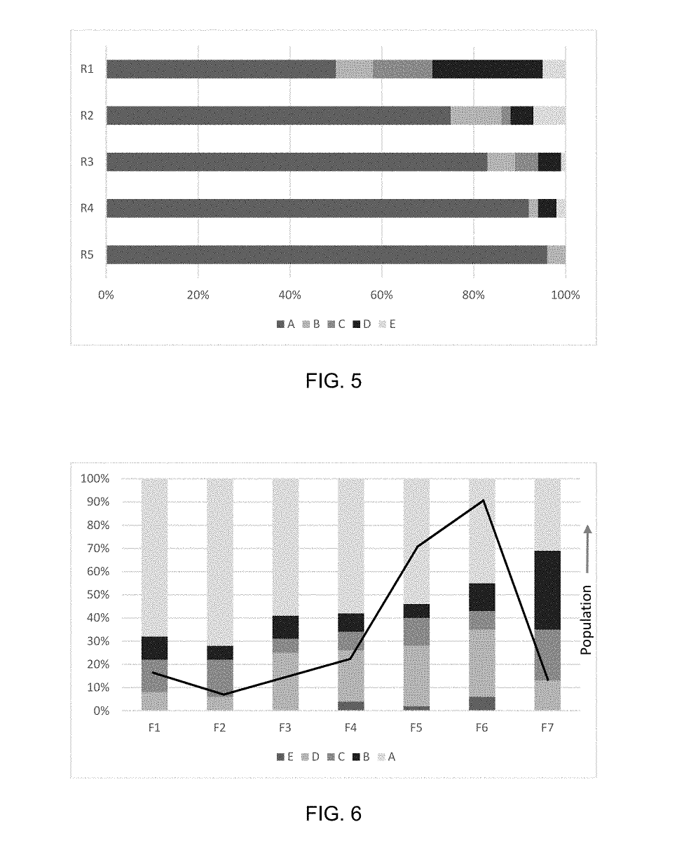

In certain embodiments, the employee retirement prediction data generated by the methods and systems disclosed herein may optionally be further manipulated by the user, e.g., as illustrated in FIGS. 5-6. In FIG. 5, a selected employee subset is categorized by retirement risk factor (A-E) as a function of geographical location (R1-R5) in a selected year. This data is also presented below in Table IV. Thus, a user can determine not only the overall number of employees at a given retirement risk level, but also the retirement prediction for individual regions, e.g., regions I-V (R1-R5) in FIG. 5. Such workforce population data may be useful, for example, to determine if a significant portion of the population in a particular region is at risk to retire in the selected year.

TABLE IV
Retirement Risk By Geographical Location

| Risk Factor | Region I | Region II | Region III | Region IV | Region V |
|---|---|---|---|---|---|
| A | 50% | 75% | 83% | 92% | 96% |
| B | 8% | 11% | 6% | 2% | 4% |
| C | 13% | 2% | 5% | 0% | 0% |
| D | 24% | 5% | 5% | 4% | 0% |
| E | 5% | 7% | 1% | 2% | 0% |

As illustrated in FIG. 6, a selected employee subset can also be categorized by retirement risk factor (A-E) as a function of division or technical area (F1-F7) in a selected year. This data is also presented below in Table V. Using this workforce population data, a user can determine not only the overall number of employees at a given retirement risk level, but also the retirement prediction for individual divisions, e.g., divisions I-VII (F1-F7) in FIG. 6. Referring to the solid line plotted in FIG. 6, the data may further be evaluated to determine if a significant portion of the employee population belongs to any particular division within the company. For instance, as shown in FIG. 6, a larger employee population exists in divisions V and VI (F5-F6) and, thus, the relatively high percentage of employees at extreme risk to retire (26%; 29%) may represent not only a significant change to the demographics of those divisions in the selected year, but also a significant impact on the employee population of the company as a whole.

TABLE V
Retirement Risk By Division

| Division | A | B | C | D | E |
|---|---|---|---|---|---|
| F1 | 68% | 10% | 14% | 8% | 0% |
| F2 | 72% | 6% | 16% | 6% | 0% |
| F3 | 59% | 10% | 6% | 25% | 0% |
| F4 | 58% | 8% | 8% | 22% | 4% |
| F5 | 54% | 6% | 12% | 26% | 2% |
| F6 | 45% | 12% | 8% | 29% | 6% |
| F7 | 31% | 34% | 22% | 13% | 0% |

Similarly, although not graphically illustrated, the employee retirement prediction data can be manipulated to display retirement risk factor as a function of employee skill level, employee cost, other like manipulations, and combinations thereof, without limitation.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A method for predicting future workforce population, the method comprising:
compiling a current employee list including an employee age category in a data storage system;
programming a computing system with an operational logic for assigning a retirement risk factor to an employee; and
using the computing system to determine an employee retirement prediction for a selected subset of the employee list in a selected year,
wherein the computing system is operationally coupled to and in communication with the data storage system.

2. The method of claim 1, wherein the operational logic assigns the retirement risk factor to the employee based on a projected employee age in a selected future year.

3. The method of claim 2, wherein the current employee list further includes an employee location category, and wherein the operational logic assigns the retirement risk factor to the employee based in part on the employee location.

4. The method of claim 1, wherein the current employee list further includes an employee skill level category, and wherein the method further comprises implementing or revising employee training programs based on the employee retirement prediction.

5. The method of claim 1, further comprising formulating a hiring framework for the selected year based on the employee retirement prediction.

6. The method of claim 5, wherein the current employee list further includes an employee skill level category and wherein formulating the hiring framework comprises assessing hiring needs for employees of a desired skill level.

7. The method of claim 5, wherein the employee list further includes an employee cost category and an employee location category, and wherein formulating the hiring framework comprises evaluating employee costs in a first geographical location and assessing potential cost savings associated with hiring employees in a second geographical location.

8. The method of claim 1, further comprising formulating a retirement incentive package based on the employee retirement prediction.

9. The method of claim 1, further comprising evaluating a potential retirement incentive package by:
determining the employee retirement prediction for the selected year;
determining a modified employee retirement prediction for the selected year with implementation of the potential retirement incentive package; and
comparing the employee retirement prediction to the modified employee retirement prediction.

10. A computer-implemented system for predicting future workforce population, the system comprising:
a data storage system for compiling a current employee list including an employee age category; and
a computing system operationally coupled to and in communication with the data storage system, the computing system comprising:
a logic subsystem programmed with an operational logic for assigning a retirement risk factor to an employee; and
a data processing subsystem for providing an employee retirement prediction for a selected subset of the current employee list in a selected year.

11. The computer-implemented system of claim 10, wherein the current employee list further includes at least one category chosen from employee location, employee skill level, and employee cost.

12. The computer-implemented system of claim 10, wherein the computing system further comprises a user input device for receiving a user query.

13. The computer-implemented system of claim 10, wherein the computing system further comprises a display device for presenting a visual representation of the employee retirement prediction.

14. The computer-implemented system of claim 10, wherein the data storage device is located remotely.

15. The computer-implemented system of claim 10, wherein the data storage system comprises computer-readable media.
